(19) United States
(12) Patent Application Publication
(10) Pub. No.: US 2005/0028428 A1
(43) Pub. Date: Feb. 10, 2005

(54) Pest trap

(76) Inventor: Hubert O. Wills, Bedford, VA (US)

Correspondence Address: RODNEY A. CORL, 2338 CATAWBA RD., TROUTVILLE, VA, 24175, US

(21) Appl. No.: 10/233,365

(22) Filed: Sep. 3, 2002

(51) Int. Cl. A01M 23/02; A01M 23/16; A01M 23/32

(52) U.S. Cl. 43/60

(57) ABSTRACT

A system designed to catch almost any kind of pest including rodents and insects. The system can be adapted for use in almost any environment (homes, businesses, factories, farms, outdoors, etc.) The system employs no poisonous sprays or powders which might be environmentally harmful and poses no danger to domestic pets or farm animals. A preferred embodiment of the present invention includes a conduit arrangement having multiple inlets opening to the ambient environment. A timer controlled vacuum motor or fan periodically induces air flow through the conduit system which will draw pests into the system. The conduit has an outlet connected to a small gas-fired furnace. The pests are injected into the furnace to be cremated. The furnace is equipped with an ash clean-out door for removal of the cremated residue, which residue may safely be disposed of.

### BACKGROUND OF THE INVENTION

1. Field of the Invention

The present invention generally relates to animal control. More specifically, the present invention is drawn to a system and process for exterminating pests.

2. Description of Related Art

Many devices have been invented to rid the environment of common flying insects such as flies, mosquitos, gnats, etc. Some of the devices employ vacuum systems to pull the insects into a bag or trap. Examples of the aforesaid devices are disclosed in U.S. Pat. No. 1,313,203 (Pakeman), U.S. Pat. No. 5,305,495 (Nelson et al.), U.S. Pat. No. 5,367,821 (Ott), U.S. Pat. No. 6,226,919 B1 (Septer) and British Patent number 259,847. The above devices employ containers (bags, bottles, etc.) to capture the insects for future disposal. No means are provided to immediately exterminate the insects.

Vacuum systems which employ pest extermination means are shown in U.S. Pat. No. 4,566,218 (Kurosawa et al.), U.S. Pat. No. 4,965,959 (Gagne), U.S. Pat. No. 5,926,997 (Wilcox), U.S. Pat. No. 5,402,598 (Wade et al.) and U.S. Pat. No. 6,202,343 B1 (Mah). The above systems use poison gas or electrocution terminals to exterminate the pests. No provision is made to cremate the pests' carcasses for use as fertilizer.

U.S. Pat. No. 5,117,578 (Theis), U.S. Pat. No. 5,214,876 (Sukup) and U.S. Pat. No. 5,974,728 (Nichols) are drawn to farm apparatus for controlling insect infestation on plants. The patentees do not contemplate the control or extermination of other pests.

U.S. Pat. No. 4,835,900 (Shifflett) discloses a multi-purpose pest trap which includes a rodent trap portion and a bug trap portion. Once trapped the rodent or bug is exterminated with carbon dioxide gas. The patent discloses no effective and expedient way to dispose of the rodent or bug carcass.

U.S. Pat. No. 4,669,216 (Moss) shows an apparatus for trapping and disposing of rodents. The trap uses bait to attract the rodent. An electric eye senses the presence of the rodent and activates a harpoon to kill the rodent. After the rodent is killed a pair of plates flatten the body and an electric coil incinerates the body. The instant apparatus would be ineffective for trapping and exterminating insects.

None of the above inventions and patents, taken either singly or in combination, is seen to disclose a pest trap as will subsequently be described and claimed in the instant invention.

### SUMMARY OF THE INVENTION

The present invention, to be dubbed the “Simplistic Trap-All”, is a system designed to catch almost any kind of pests including rodents (mice, rats, ground squirrels, etc.) and insects (flies, mosquitos, wasps, etc.). The instant system employs no poisonous sprays or powders which might be environmentally harmful. The Simplistic Trap-All system is clean, efficient and poses no danger to domestic pets. The system can be adapted for use in almost any environment (homes, businesses, factories, farms, outdoors, etc.)

The preferred embodiment of the present invention comprises a conduit arrangement having at multiple inlets opening to the ambient environment. A timer-controlled vacuum motor or fan periodically induces air flow through the conduit system, thus drawing insect pests into the conduit system. The conduit arrangement has an outlet connected to a small gas-fired furnace. The pests, drawn through the conduit arrangement, are injected into the furnace to be cremated. The furnace is equipped with an ash clean-out door for removal of the cremated residue, which residue may safely be disposed of. For example, the residue would make a safe, clean and very good fertilizer.

A second embodiment of the invention is designed to attract larger pests and incorporates a one-way valve or door to prevent the pests from escaping. The second embodiment utilizes a larger (diameter) conduit arrangement to accommodate the larger pests. The second embodiment may also include a device which functions to crush the skull of the pest before the pest is injected into the furnace.

Accordingly, it is a principal object of the invention to provide an efficient system for trapping pests.

It is another object of the invention to provide a system for: efficiently exterminating pests.

It is a further object of the invention to provide a system which cremates the trapped pest's carcass.

Still another object of the invention is to provide a pest trapping and exterminating system which is effective, clean and easy to use.

It is an object of the invention to provide improved elements and arrangements thereof in an apparatus for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of a first embodiment of a pest trap according to the present invention.

FIG. 2 is a partial perspective view of a second embodiment of a pest trap according to the present invention.

FIG. 3 is a partial perspective view of a third embodiment of a pest trap according to the present invention.

Similar reference characters denote corresponding features consistently throughout the attached drawings.

### DETAILED DESCRIPTION OF THE PREFERRED EMBODIMENTS

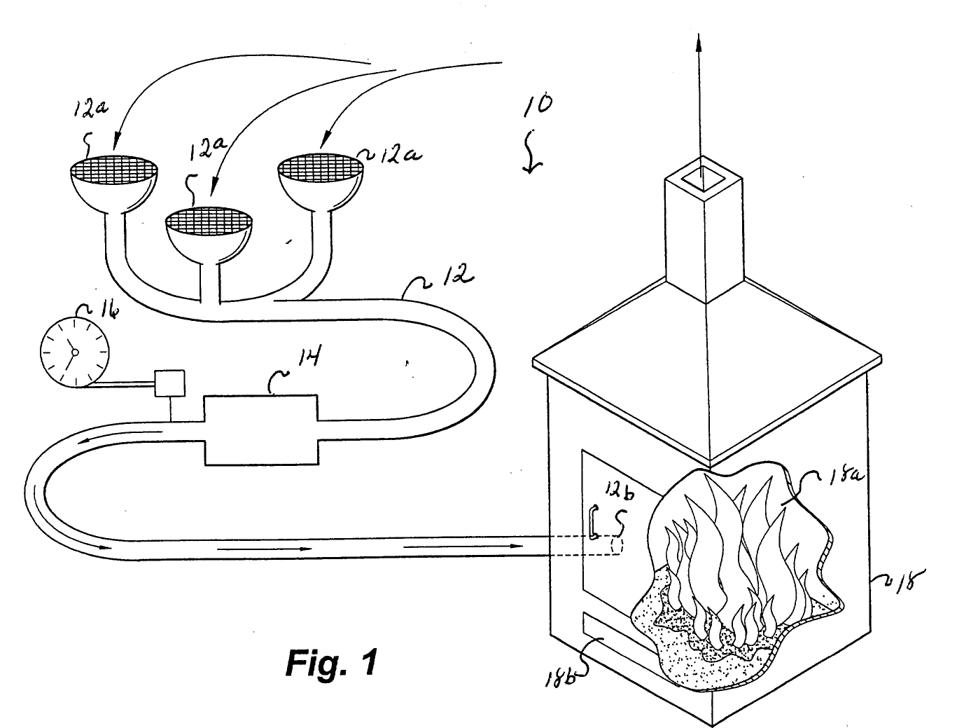

Attention is first directed to FIG. 1 wherein a first embodiment of the pest trap apparatus is generally indicated at 10. Apparatus 10 comprises a conduit system or network 12. Conduit network 12 is provided with multiple inlets 12a whereby small pests may gain entrance. Although three inlets are shown, more or fewer may be provided as necessary. Inlets 12a may be baited to attract the pests if desired. A vacuum motor 14 is interposed in conduit 12 to induce air flow and draw light-weight pests into the conduit. A timer 16 is connected to the motor and functions to periodically turn the motor on and off. The frequency of operation may be determined by the user. Conduit 12 has an outlet 12b which exits into the combustion chamber 18a of a gas-fired furnace 18. A clean-out door 18b is provided so that the cremation ashes may be removed from the furnace.

In use, the operation of vacuum motor 14 will cause pests in the vicinity of inlets 12a to be drawn into and through conduit 14. The pests will be deposited in combustion chamber 18a and cremated therein.

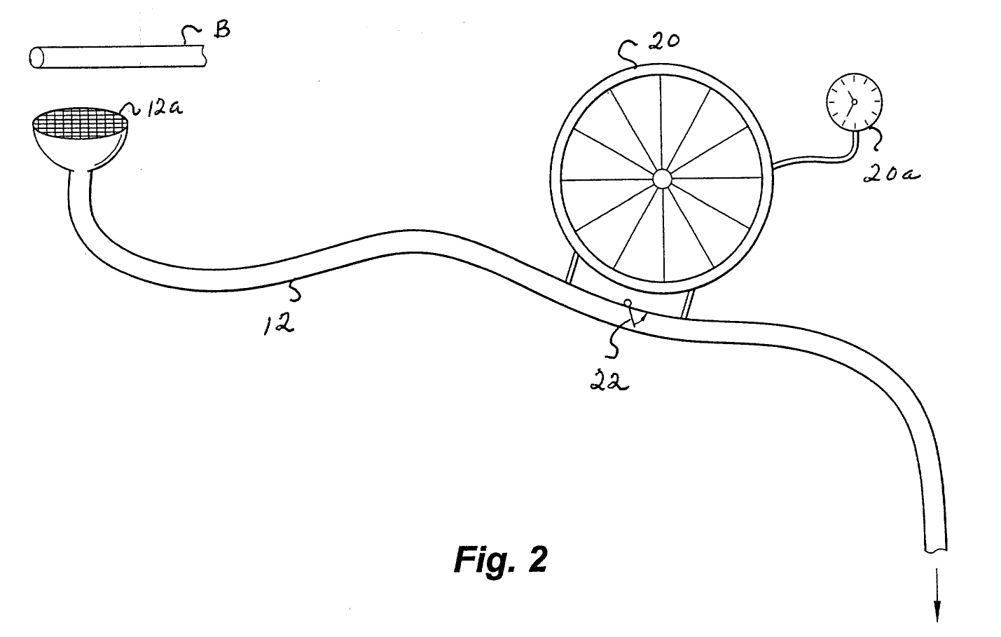

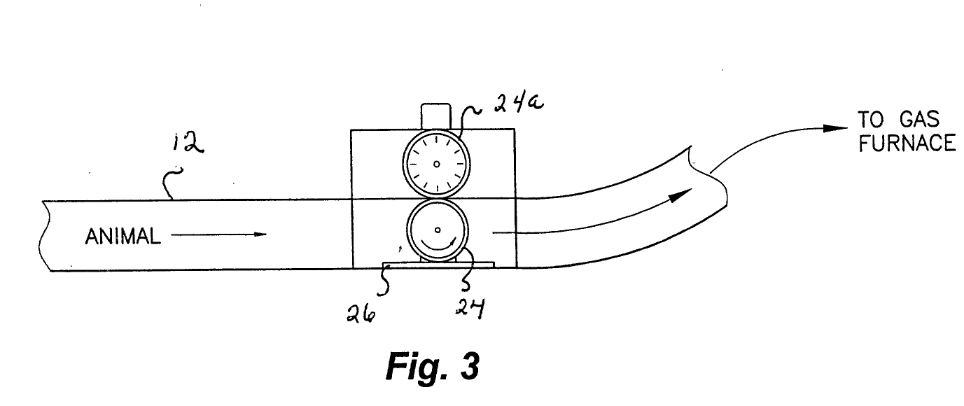

Attention is now directed to FIGS. 2 and 3 wherein the system is adapted to trap larger pests. The conduit 12 is fashioned with a larger diameter than that of FIG. 1 to accommodate the larger and weightier pests. As noted above, a bait B may be employed to attract the larger pests. Bait B may take on the form of any commercially available non-toxic bait. A blower or fan 20 (FIG. 2) having a timer 20a is utilized to induce air flow through the conduit. The induced air flow may not be strong enough to pull the larger pest efficiently through conduit. To this end, a one-way valve or door 22 is provided to prevent the larger pests from escaping. As an adjunct, an adjustable metal or plastic roller 24 (FIG. 3) is disposed above a metal plate 26 to crush and kill the pest before the pest carcass is deposited in the furnace combustion chamber. Plastic roller 24 is powered by an electric motor 24a. The slope of the conduit will be in a downward direction to enhance pest movement toward the furnace. The timer 20a, electric motor 24a and furnace 18 may be correlated to function in unison.

It is to be understood that the present invention is not limited to the sole embodiments described above, but encompasses any and all embodiments within the scope of the following claims.

1. An apparatus for trapping and exterminating pests comprising:
an elongate conduit, said conduit having at least one inlet to provide access for pests to the elongate conduit and an outlet to provide egress for pests;
means for inducing an air flow in said conduit system from said at least one inlet to said outlet;
a timing device, said timing device connected to said means to periodically activate said means to induce said air flow;
a gas furnace, said gas furnace having a combustion chamber connected to said outlet, whereby said pests are injected into said combustion chamber for cremation therein.

2. An apparatus for trapping and exterminating pests according to claim 1, wherein said means is a vacuum inducing motor.

3. An apparatus for trapping and exterminating pests according to claim 1, wherein said means is a fan.
